(19) United States
(12) Patent Application Publication
(10) Pub. No.: US 2010/0258656 A1
(43) Pub. Date: Oct. 14, 2010

(54) MEANS FOR ALIGNING AND PRE-STRESSING COMPONENTS OF A FUEL INJECTOR ASSEMBLY

(75) Inventors: Stephen O. Crossley, Kent (GB); Malcolm David Dick Lambert, Kent (GB)

Correspondence Address: DELPHI TECHNOLOGIES, INC, M/C 480-410-202, PO BOX 5052, TROY, MI, 48007, US

(73) Assignee: DELPHI TECHNOLOGIES, INC., TROY, MI (US)

(21) Appl. No.: 12/745,791

(22) PCT Filed: Dec. 3, 2008
(86) PCT No.: PCT/GB08/51149

§ 371 Date: Jun. 2, 2010

(30) Foreign Application Priority Data
Dec. 5, 2007 (GB) 0723785.2

(51) Int. Cl. B05B 1/30

(52) U.S. Cl. 239/584

(57) ABSTRACT

A fuel injector for an internal combustion engine, the fuel injector being of a type with an open-ended nozzle body adjoining an injector body. The interface between the nozzle body and the injector body is flat, to simplify manufacture, and they are aligned relative to each other using a compression element which is typically a sleeve that extends around them. The compression element also acts to apply a pre-compression to at least one of the bodies to enable the fuel injector to operate at higher fuel pressures than would otherwise be possible.

### TECHNICAL FIELD

The invention relates to a fuel injector assembly for use in a diesel internal combustion engine and in particular to the arrangement of a nozzle body and an injector body within such a fuel injector assembly.

### BACKGROUND OF THE INVENTION

To improve engine performance, diesel fuel injector technology is continuously being driven to operate at higher injection pressures. This trend has lead to an increased demand on the strength of components of the fuel injection system, in particular, in the ability of those components to resist hoop stress resulting from the internal fuel pressure. The demand for increased fuel injection pressures is set to continue into the future, and has created significant manufacturing challenges as well as having cost implications.

### SUMMARY OF THE INVENTION

By way of example, current fuel injection systems are designed for operation at fuel pressures of up to 2,500 bar. However, in some circumstances it may be desirable to have a fuel injection system that is capable of withstanding fuel pressures of 3,000 bar or more. Although existing high fuel pressure-resistant designs incorporate advanced precision machining to minimise the risk of component failure, it is possible that this may have already reached the limits of cost-effectiveness.

Accordingly, the present invention provides a fuel injector comprising an open-ended nozzle body, an injector body and a valve member engaged with a valve member guide in the nozzle body and a valve member guide in the injector body characterised in that the mating interface between the nozzle body and the injector body is substantially flat and in that a compression element is engaged with at least a part of each of the nozzle body and the injector body wherein the compression element applies a compressive stress to at least one of the nozzle body and the injector body.

The interface is substantially flat to simplify the machining processes involved in the manufacture of the components. This reduces the cost of the components.

In a preferred embodiment, the nozzle body has a wall defining an internal chamber for high pressure fuel, the wall having an internal and an external surface, and wherein the compression element has an inner peripheral surface defining an aperture in which at least a portion of the nozzle body is received, in use, wherein the compression element is arranged for engagement as an interference fit with at least a portion of the external surface of the wall of the nozzle body, such that a radial compressive force is exerted on the wall of the nozzle body.

In a preferred embodiment the nozzle body is located axially adjacent the injector body and the compression element is arranged for engagement with at least a portion of the external surface of the injector body and at least a portion of the external surface of the nozzle body.

In a preferred embodiment the compression element is a sleeve.

The pressure of the fuel that can be used in fuel injection systems is primarily limited by the hoop stress, caused by the internal hydraulic pressure, which is experienced by components of the fuel injection system that contain or passage high-pressure fuel. Advantageously, the present invention reduces the hoop stress on the components of the fuel injector by introducing a pre-compression on at least a section of the wall of those components. In fact, the shape and interface between the component and the compression sleeve may be tailored to target the compressive stress into the most beneficial areas. The pre-compressive force is directed radially inwards toward the internal chamber of the component so as to counteract the hoop stress exerted radially outwards through the walls of the component. In this way, the use of pre-compression increases the internal fuel pressure that can be withstood by the component to a greater extent that would be achieved by simply increasing the thickness of the wall of the component by the equivalent thickness of the compression sleeve. Furthermore, the compression sleeve may engage an external surface of the one or more components in a manner such that it does not alter or interfere with the inner form of the component and, therefore, the functioning of the component (e.g. its fluid dynamic properties) is not adversely affected.

Conveniently, to match the shape of many of the components of known fuel injection systems, the aperture of the compression sleeve is of generally cylindrical shape, which is defined by an inner peripheral surface of average inner radius (R1). The compression sleeve may also have a generally cylindrical outer peripheral surface with an average outer radius (R2). Accordingly, the radial thickness (T) of the compression sleeve may be defined between the inner and outer peripheral surfaces of the compression ring.

The radial thickness (T) of the compression sleeve may be selected on the basis of one or more functional considerations, such as: the amount of radial compressive force to be exerted on the component, and hence, the intended increase in internal fuel pressure to be accommodated by the component; and/or the material of the compression sleeve. Another consideration is the intended amount of interference between the compression sleeve and the component to be engaged, because a greater amount of interference leads to increased stresses on the compression ring. In this regard, the radial thickness of the compression ring should be large enough to withstand the stress experienced around the compression sleeve on engagement with the component. Thus, although in theory the compression ring can have any appropriate thickness (e.g. from 0.1 to 10 mm); suitably the radial thickness (T) is between 0.5 and 5 mm; more suitably between 0.75 and 3 mm; and still more suitably between 1 and 2 mm. In some embodiments, the radial thickness of the compression sleeve is determined by the available space between components within a known internal combustion engine into which the compression ring is intended to fit. In one advantageous embodiment, therefore, the radial thickness (T) of the compression sleeve is approximately 1.2 mm.

Beneficially, the compression sleeve may be arranged for engagement with a desirable region (or portion) of the external surface of the wall of a component of a fuel injection system, such that the pre-compression is targeted to a specific location. For example, the compression sleeve may suitably be arranged for engagement with the external surface of the wall of the first component in a region of that component that experiences the greatest hoop stress, in use. Suitable specific target regions may be selected in any way known to the person of skill in the art, for example, by 3D or 2D axis-symmetric, non-linear finite element analysis (FEA) modelling techniques that identify the relative stresses experienced by regions of a structure. In other embodiments, the compression sleeve may be arranged for engagement with the component at regions of reduced wall thickness, wall regions that bound enlarged internal chambers for high-pressure fuel, and interfaces between adjacent components of the fuel injection system, such as fuel passages and pipes or adjacent bodies within a fuel injector.

The maximum internal (fuel) pressure that can be withstood by an engine component, before and after addition of a compression sleeve, can be predicted/calculated in any manner known to the person skilled in the art. For example, in a similar manner to that mentioned above, FEA software and/or thick cylinder equations, may be used to give calculated (predictive) results, which may be compared to testing results using sample parts.

The compression sleeve may be arranged for engagement with any suitable component of a fuel injection system, such as a fuel injector assembly or an element of a fuel injector assembly. The fuel injector assembly of the invention may comprise any suitable component of a fuel injector and a compression sleeve arranged for engagement therewith.

In a suitable embodiment, the compression sleeve is arranged for engagement with an external surface of a nozzle body of a fuel injector assembly. Typically, in use, a fuel injector assembly comprises a nozzle body that is at least partially received within a cap nut of the fuel injector. The cap nut, at least in part, functioning to hold the various components of the fuel injector together. Thus, in some embodiments, the compression sleeve is arranged for engagement with at least a portion of the external surface of the nozzle body that is, in use, received within the cap nut. Advantageously, the compression sleeve is arranged to fit within an internal volume of a known fuel injection assembly: for example, between an external surface of a known nozzle body and an internal surface of a known injector cap nut; so that the benefits of the invention can be achieved without modifying the form of the cap nut. In such embodiments, (depending on the design of the fuel injector assembly), a suitable radial thickness of the compression sleeve is approximately 1.2 mm, this being a suitable thickness to fit within the available volume.

The nozzle body is provided with an axially extending bore for receiving a valve needle.

Generally, a known fuel injector comprises an injector body located axially adjacent a nozzle body. Therefore, the compression sleeve of the invention may be arranged for engagement with at least a portion of the external surface of the injector body and at least a portion of the external surface of the nozzle body. In this way, the compression sleeve spans the interface between the injector body and the nozzle body and may further function to improve or enhance the axial alignment of these components within a fuel injector assembly. For instance, the concentricity of the injector body and the nozzle body and/or the seal at the interface between these two parts may be advantageously improved.

As the person skilled in the art will appreciate, the amount of inwards radial force exerted by the compression sleeve, in use, is at least in part determined by the amount of interference between the inner peripheral surface of the compression sleeve and the external surface of the component to be engaged.

As used herein, an “interference fit” (sometimes called a press fit) is a fastening between two components which is achieved by friction after the parts are pushed together. The frictional force that holds the parts together may be greatly increased by the compression of one part against the other, which relies on the tensile and compressive strengths of the materials from which the parts are made. An interference fit is generally achieved by shaping the two mating parts so that one or the other (or both) slightly deviate in size from the nominal dimension, and so that one part slightly interferes with the space that the other component is taking up: the result is that when the parts are engaged with each other they elastically deform slightly (each being compressed).

Thus, as used herein, the term “interference”, is meant to indicate that there is a negative difference in size (e.g. a radial difference) between the aperture of the compression sleeve that receives the component and the external surface of the component; i.e. the aperture has the smaller size (e.g. a smaller radius). The degree/category of the interference can be inferred from accompanying statements or measurements, where given.

In accordance with the invention, an interference fit—rather than a “sliding fit” (for example), between the compression sleeve and the component that is to be received within an aperture of the compression sleeve—is employed in order that the component experiences a pre-compressive force from the compression ring. Accordingly, unless otherwise stated, the term “interference fit” is used herein to encompass both a “light interference fit” and an “interference fit” (both of which require a negative size difference between the aperture of the compression ring and the external surface of component to be engaged), but not a loose or sliding fit.

The person skilled in the art is well aware of formulae that exist to calculate the allowance (planned difference from the nominal size) that will result in various strengths of fit between two parts, such as: “loose fit”, “light interference fit”, and “interference fit”. The value of the allowance depends on which material is being used, how big the parts are, and what degree of tightness is desired. By way of example, the person skilled in the art may determine the amount of “interference” from a look-up table, such as a Limit and Fit table, which indicates the amount of interference required to achieve a desired compressive force: in dependence on various parameters, such as the external diameter of the component in the region engaged by the compression sleeve, and the amount of force that is required to physically engage the parts. Thus, if it is desirable to design a compression sleeve for a light interference fit engagement with a 14.3 mm diameter nozzle body made of hardened steel, the person skilled in the art can readily find the necessary interference (in μm) that is necessary between the compression sleeve and the nozzle body using, for example, a reference book or computer program.

In some embodiments of the invention a light interference fit is convenient so that the compression sleeve may be assembled with the component by a manual press fit; or if tighter, by way of a machine press fit. With such a fit, after installation, the compression sleeve will not move along the external surface of the component unless at least as much force as the assembly force is used. For example, the compression sleeve will not slide or shift during normal use. For a tighter degree of fit (as may be referred to in the art as an interference fit rather than a light interference fit), the compression sleeve may be assembled on the component by machine press fit or, if too tight for a machine press fit, by heat expansion and/or contraction. Thus, by way of example, when a tighter fit is desired between the compression sleeve and the component with which it is to be assembled, the compression sleeve may be heated to expand its aperture before assembly. In the alternative, the component of the engine or fuel injector assembly may be cooled to shrink it relative to the aperture of the compression sleeve before assembly. In some cases, both heating of the compression sleeve and cooling of the component may be used prior to assembly.

In some embodiments in may be advantageous to chamfer (or bevel) one or both edges of the compression sleeve in order to help guide the compression sleeve over the component during assembly.

Any suitable size of interference can be used, depending on the desired level of pre-compression of the component and the respective sizes of the components. For instance, a relatively smaller amount of interference may be employed with a relatively small diameter component than for a larger diameter component, in order to produce the same amount of pre-compression. As already noted, the skilled person can determine the degree of interference necessary for any particular embodiment by referring to a look-up table, computer program or by routine experimentation. For example, the compression sleeve may be arranged for engagement with the first and/or second component with an interference (I) of from 5 to 45 μm (between the inner peripheral surface of the compression sleeve and the external surface of the one or more components). In some beneficial embodiments, the interference may be designed to be between 10 and 39 μm. Suitably, the interference may be between 15 and 20 μm. In some embodiments, an interference of approximately 15 μm or approximately 20 μm is used, for example, in cases where this is the maximum interference that allows the compression sleeve to be engaged with the component by manual press fit. When the desired amount of interference is greater, in use, the compression sleeve is conveniently engaged with the component by machine press fitting and in some advantageous embodiments, by shrink fitting.

The compression sleeve may be formed with any suitable dimension of inner radius (R1); outer radius (R2) and hence, radial thickness (T); and axial length (L), depending on the size and shape of the component(s) with which the compression ring is intended to engage. By way of example: the inner radius (R1) may be between 1 and 50 mm, such as between 2 and 25 mm, or between 3 and 15 mm; the outer radius (R2) may be between 2 and 60 mm, such as between 3 and 30 mm, or between 4 and 20 mm; the radial thickness (T) may be between 0.1 to 10 mm, suitably between 0.5 and 5 mm, more suitably between 0.75 and 3 mm, and still more suitably between 1 and 2 mm; and the axial length (T) may be between 3 and 200 mm, such as between 4 and 100 mm, between 5 and 50 mm or between 5 and 20 mm. In some more specific embodiments, the compression sleeve may have an inner radius (R1) of between 5 and 10 mm, an outer radius (R2) of between 6 and 12 mm, a radial thickness (T) of between 1 and 2 mm, and an axial length (L) of between 4 and 8 mm.

In a specific embodiment, wherein the compression sleeve is arranged for engagement with a known nozzle body with a target region having an external diameter (D1) of approximately 14.3 mm, the compression sleeve conveniently has an inner radius (R1) of approximately 14.3/2 mm (i.e. approximately 7.15 mm), an outer radius (R2) of approximately half the external diameter (D2) of the compression sleeve, 16.7/2 mm (i.e. approximately 8.35 mm) and an axial length (L) of approximately 6 mm. In such an embodiment, the compression sleeve may be arranged to interfere with the nozzle body by any desired amount, and conveniently between 10 and 39 μm or between 10 and 28 μm. In one embodiment, the interference (I) is approximately 15 μm. Such a compression sleeve is particularly suitable for engagement with a known nozzle body in a region that is housed within a cap nut of a fuel injector, in use, without the need to modify the shape of either the nozzle body or the cap nut. It should be appreciated, however, that where a desirable level of pre-compression cannot be achieved using a compression sleeve that is suited to the existing dimensions of a known fuel injection system, it may be necessary to structurally alter one or more components of a fuel injection system. Where higher levels of compression are required and a thicker compression ring is necessary, it may be convenient to modify the shape of the injector cap nut.

The compression sleeve as used in accordance with the invention may be made from any suitable material, and typically from a metal material, such as a metal alloy. It is convenient to manufacture the compression sleeve from the same material as the component that is it arranged to engage, for example, steel, such as a low carbon steel. In some cases a tool steel may be used. The grade of steel (other metal or metal alloy) may be selected in accordance with the desired strength of the compression sleeve, so as to optimise the design for a particular use. For example, the metal may conveniently be heat treated to increase its tensile strength and/or its hardness. In addition, a high hardness level may aid assembly. A high tensile material, such as a hardened metal alloy or steel may be appropriate for most uses.

These and other aspects, objects and the benefits of this invention will become clear and apparent on studying the details of this invention and the appended claims.

### BRIEF DESCRIPTION OF THE DRAWINGS

The invention will further be described, by way of example, with reference to the accompanying drawings, in which:

FIG. 1 is an enlarged cross-sectional view of a known fuel injector;

FIG. 2A is a cross-sectional view of a galleried nozzle body of a fuel injector fitted with a compression sleeve adjacent to the annular fuel gallery;

FIG. 2B is a cross-sectional view of the compression sleeve of FIG. 2A through the line “a” in FIG. 2A;

FIG. 3 is a cross-sectional view of a galleried nozzle body of a fuel injector fitted with a compression sleeve adjacent to the valve needle;

FIG. 4 is a cross-sectional view of an open-ended nozzle body of a fuel injector fitted with a compression sleeve;

FIG. 5 is a cross-sectional view of the open-ended nozzle body and injector interface of the fuel injector of FIG. 4; and

FIG. 6 is a cross-sectional view of an open-ended nozzle body of a fuel injector in accordance with the present invention.

### DESCRIPTION OF THE EMBODIMENT OF THE INVENTION

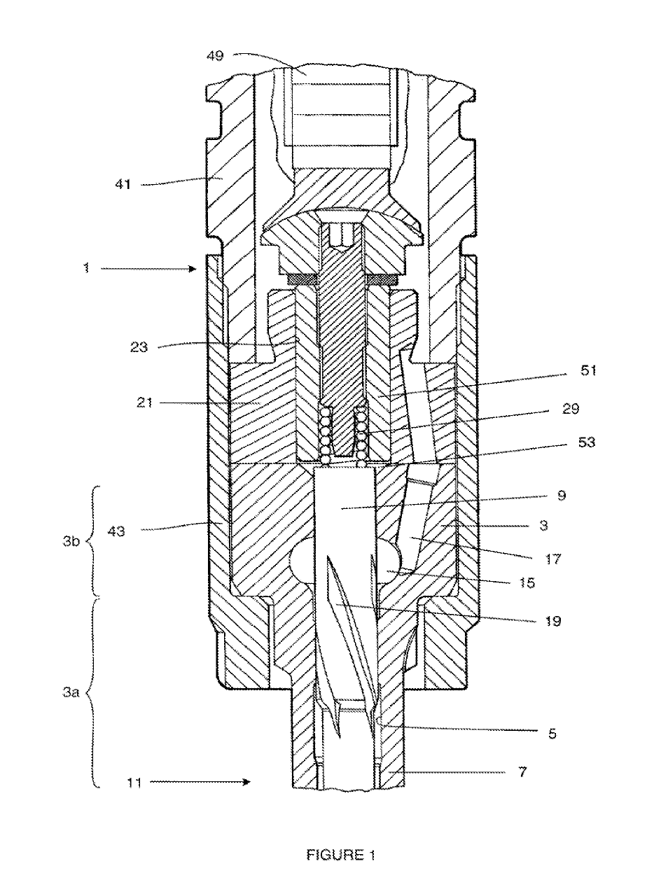

Referring to FIG. 1, a fuel injector 1 comprises an injection nozzle 11, which comprises a nozzle body 3 having a first region 13a (including a nozzle stem 7) of relatively small diameter extending towards a nozzle tip (not shown) and a second region 13b of relatively large diameter distal to the nozzle tip. The nozzle body 3 is provided with an axially extending blind (nozzle) bore 5, the blind end of which is terminates at the nozzle tip (not shown). Disposed within the bore 5 is a valve member 9 having a tip (not shown), in the form of an elongate needle. The valve member 9 is slidable within the bore 5, such that the tip can engage and disengage a valve seat (also not shown) defined by an inner surface of the nozzle tip. The nozzle tip is provided with one or more apertures or spray holes (not shown) in communication with the bore 5. Engagement of the tip with the valve seat prevents fluid escaping from the valve body 3 through the apertures, and when the tip is lifted from the valve seat, fluid (e.g. fuel) may be delivered through the apertures into an associated engine cylinder (not shown).

Within the second region 13b of the nozzle body 3, the bore 5 defines a region of increased diameter, in the form of an annular gallery 15. The annular gallery 15 communicates with a fuel supply line 17 arranged to receive high-pressure fuel from an accumulator of an associated fuel delivery system. In order to allow fuel to flow from the annular gallery 15 towards the nozzle stem 7, the valve needle 9 is provided with a fluted region 19 which also acts to restrict lateral movement of the valve needle 9 within the valve body 3. The valve needle 9 is further shaped such that the region that extends through the bore 5 in the nozzle stem 7 is of smaller diameter than the bore 5, so that fuel can flow between the valve needle 9 and the inner surface of the valve body 3.

It should be appreciated that the structure and components of prior art fuel injectors may vary depending on design requirements and use. However, as depicted, the fuel injector 1 further comprises an injector body 21 shaped to define a chamber 53 for receiving high pressure fuel, which communicates with the distal end of the valve member 9; and a compression spring 29 for biasing the valve member against its valve seat. In addition, as depicted, the injector body 21 defines a bore 23 for receiving a control piston 51 responsive to an actuator, in the form of a piezoelectric actuator 49.

To assemble the fuel injector 1, the injector body 21 and nozzle body 3 are mounted on a nozzle holder 41 by means of a cap nut 43. Typically, a screw-threaded engagement is provided to secure the cap nut 43 onto the nozzle holder 41. The nozzle holder 41, as depicted, includes a recess within which a piezoelectric actuator 49 is provided.

In some embodiments, a plate or other “body” (not shown) may be provided between the nozzle body 3 and the injector body 21.

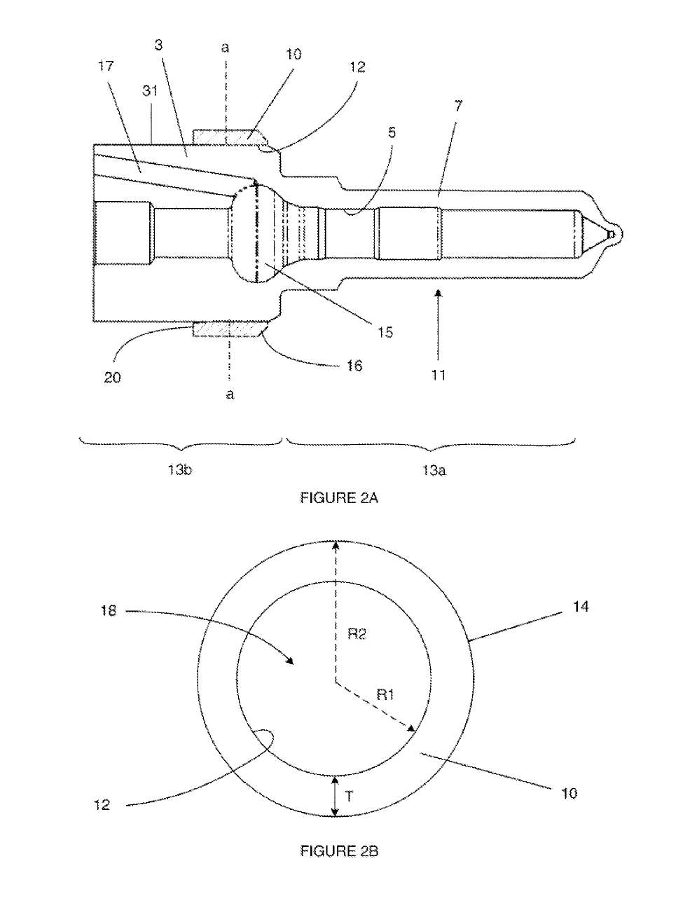

In the description of the following FIGS. 2 to 7, like reference numerals to those of FIG. 1 are used for like parts, although it should be appreciated that the structure, size and shape of those like parts may vary.

Referring to FIGS. 2A and 2B a component set for a fuel injection system of an internal combustion engine comprises a nozzle body 3 and a compression sleeve 10. The nozzle body 3 is provided with a bore 5 for receiving a valve member (not shown), and an annular gallery 15 defined by an enlarged diameter region of the bore 5 within the second region 13b of the nozzle body 3. The compression sleeve 10, in the form of cylinder, is provided with a cylindrical (or circular) aperture 18, which is so shaped to receive at least a portion of the second region 13b of the nozzle body 3.

To assemble the component set, the compression sleeve 10 may conveniently be inserted over the first region 13a and nozzle stem 7 of the nozzle body 3 and then pushed firmly (press fit) down onto the wider second region 13b of the nozzle body 3. In an alternative, the compression sleeve 10 may be shrunk fit onto the nozzle body 3 using heat. The compression sleeve 10 is arranged such that its inner peripheral surface 12 engages with the external surface 31 of the nozzle body 3 as an interference fit so that once the final position of the compression sleeve 10 on the nozzle body 3 has been selected, it will not move from that position in normal use of the fuel injector assembly. Accordingly, the inner radius R1 is arranged to be slightly smaller than the radius of the nozzle body 3. As already described, any suitable interference (I) may be used, such as between 5 and 50 μm or between 10 and 39 μm. Conveniently, an interference of between 15 and 20 μm may be selected to allow assembly by manual or machine press fit. In the embodiment depicted, the compression sleeve 10 is located on the external surface 31 of the wall of the nozzle body 3 such that it axially overlaps the axial position of the annular gallery 15. The term “axial” as used in this context refers to the long axis of the nozzle body 3, the nozzle stem 7 and the bore 5 of the nozzle body 3. It will be appreciated that it other embodiments, the compression sleeve 10 may be axially positioned on the nozzle body such that the gallery entirely lies within the first 16 and second 20 edges of the compression sleeve 10. Alternatively, it should be appreciated that where the nozzle body 3 does not define an annular gallery 15, a compression sleeve 10 in accordance with the invention may still be arranged for engagement with the second region 13b of the nozzle body 3.

As depicted in FIG. 2A, the compression sleeve 10 has a first edge 16 that is bevelled, while the second edge 20 is substantially flat. In alternative embodiments one, both or neither of the first or second edges 16, 20 may be bevelled, for example: in order to assist in the assembly of the compression sleeve 10 on the component; or to improve the fit of the compression sleeve 10 against other engine components.

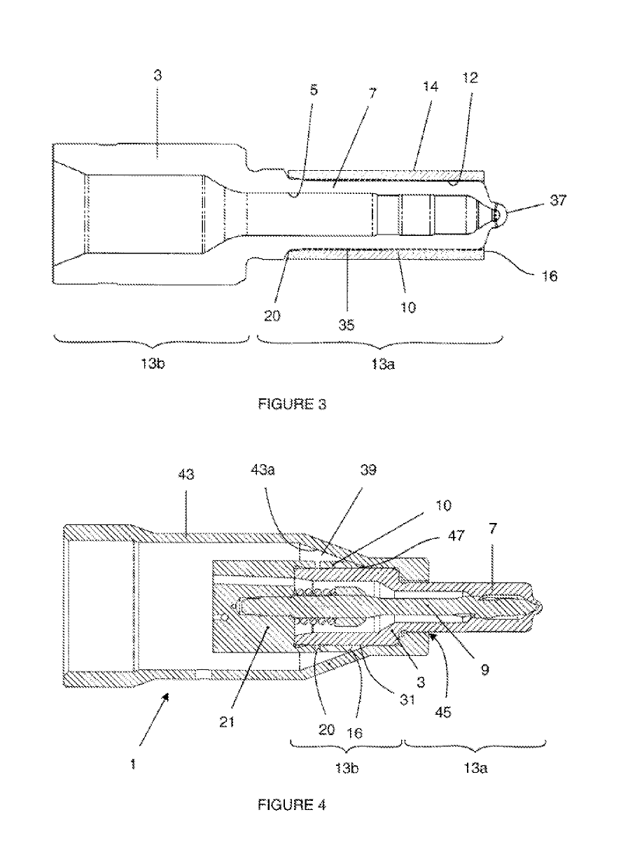

FIG. 3 shows an alternative component set for a fuel injection system of an internal combustion engine, which comprises an open-ended nozzle body 3 and a compression sleeve 10. The open-ended nozzle body 3 has an internal cross-sectional profile that is provided with a single guide section towards the tip of the nozzle body 3 to guide the valve needle 9. To ensure that the valve needle 9 is adequately guided within the injector a second valve needle guide (not shown) is provided in the injector body (not shown). The injector body adjoins the nozzle body 3 when the injector is in its assembled form.

In the preferred embodiment there is no annular gallery 15 within the second region 13b of the nozzle body 3. However, it will be appreciated that such an annular gallery may be provided in other similar embodiments.

The compression sleeve 10, in the form of an elongate cylinder, is provided with a cylindrical (or circular) aperture (not shown) which is so shaped to receive the nozzle stem 7 of the nozzle body 3. As depicted, the compression sleeve 10 has an axial length L substantially equal to the length of the nozzle stem 7, such that the inner peripheral surface 12 of the compression sleeve 10 engages substantially the entire external surface 35 of the nozzle stem 7. In this way, a radially inwards compressive force is exerted by the compression sleeve 10 over the entire length of the wall of the nozzle stem 7. In the embodiment shown, both the first and second edges 16, 20 of the compression sleeve 10 are substantially flat. However, as before, one or both edges may be bevelled or chamfered to aid in assembly or to improve the fit of the compression sleeve 10 against the nozzle body 3 or other components (not shown). For example, the second edge 20 may be bevelled to improve the fit against the wall of the nozzle body 3 between the first and second regions 13a, 13b.

To assemble the component set, the compression sleeve 10 is placed against or over the tip 27 of the nozzle stem 7 and forced along the nozzle stem 7 as previously described.

It should be appreciated that in alternative embodiments, the compression sleeve 10 may be arranged to engage a portion, rather than the whole, of the external surface 35 of the nozzle stem 7. For example, the axial length L of the compression sleeve 10 may be any proportion from 1 to 100% of the length of the valve stem 7. In an advantageous embodiment, the compression sleeve engages substantially the entire length of the nozzle stem 7 (e.g. over 50%, suitably between approximately 80 and 100% or 90% and 100%, and most suitably approximately 100%).

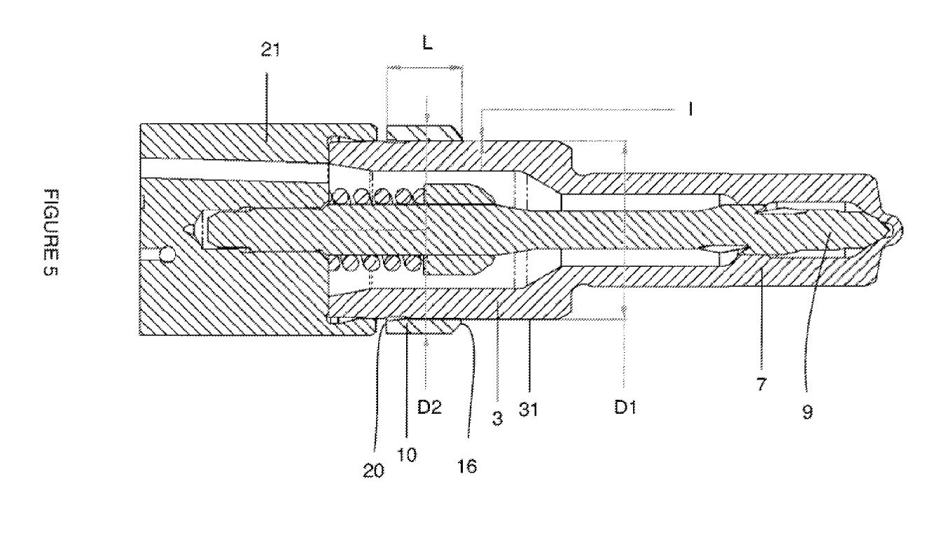

FIG. 4 depicts another embodiment of a component set. In this figure, the compression sleeve 10 is shown, in use, within a fuel injector assembly.

The fuel injector assembly 1 comprises a cap nut 43, which houses the injector body 21 and at least a part of an open-ended nozzle body 3. The larger diameter second region 13b of the nozzle body 3 is entirely housed within the cap nut 43 and the major part of the smaller diameter first region 13a, including the greater part of the nozzle stem 7, protrudes from an aperture 45 in the cap nut 43. The internal surface 43a of the cap nut 43 is spaced apart from the external wall 31 of the second region 13b of the nozzle body 3, such that an annular volume 39 is defined between the cap nut 43 and the nozzle body 3. Conveniently, the compression sleeve 10 is adapted to engage with the external wall 31 of the nozzle body 3 within the volume 39, so that it is not necessary to modify either the nozzle body 3 or cap nut 43 in order to accommodate the compression sleeve 10. The chamfered first edge 16 of the compression sleeve is arranged so that it does not hinder the assembly of the fuel injector assembly, for example, by obstructing the conical region 47 of the cap nut 43.

Notably, in the embodiment of FIG. 4, the nozzle body 3 does not include an annular gallery 15, but in alternative embodiments, an annular gallery may be present. In such cases, the compression sleeve 10 may be located within the cap nut 43 in axial overlapping relationship with an annular gallery 15 in the nozzle body 3 (as previously described).

In FIG. 5 a specific embodiment of a compression sleeve 10 arranged for use with a known open-ended nozzle body 3 is shown in relation to a component set as depicted in FIG. 4.

In this embodiment, the second region 13b of the nozzle body 3 has a nominal diameter (D1) of approximately 14.3 mm to the external surface 31 that is engaged by the compression sleeve 10. Accordingly, the inner radius R1 of the compression sleeve is approximately 14.3/2 mm (i.e. approximately 7.15 mm nominal), except that it is arranged to have a 0.015 (15 μm) radial interference indicated at I. The outer diameter of the compression sleeve 10 is approximately 16.7 mm (nominal), so that the radial thickness T of the compression sleeve 10 is approximately 1.2 mm. As indicated, the compression sleeve 10 has a length L of 6 mm from the first edge 16 to the second edge 20. In this way, the compression sleeve 10 can be used within a known fuel injector assembly 1 without requiring structural modifications to any components (such as the nozzle body 3 and the cap nut 43) of the fuel injector assembly.

Although the above dimensions are representative of a particularly suitable embodiment, in other embodiments, for example: when the compression sleeve is arranged for engagement with a nozzle body of slightly different dimensions; when a lightly different amount of pre-compression is desired; or when it is desired to target the pre-compression in slightly different regions of the nozzle body, the dimensions described in respect of the embodiment of FIG. 5 may be varied slightly. By way of example, it may be desirable to vary the length L within the range of 4 to 8 mm, such as between 5 and 7 mm Likewise, the radial thickness T of the compression sleeve 10 may be variable between 0.5 and 2 mm, such as between 1 and 1.5 mm, (provided the compression sleeve 10 does not interfere with the assembly of the fuel injector). As regards the inner radius R1 of the compression sleeve 10, it will be appreciated that this dimension is entirely dependent on the external diameter (D1) of the component with which the compression sleeve 10 is intended to engage, and the desired amount of interference (I).

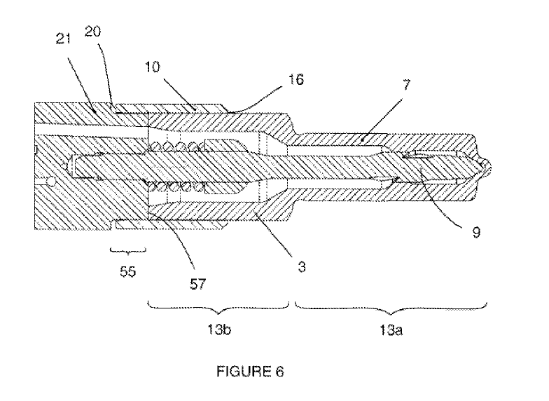

Referring to FIG. 6, an embodiment and use of a compression sleeve 10 in accordance with the present invention is shown.

In this embodiment, the fuel injector assembly is depicted with an open-ended nozzle body 3 in contacting mating relationship with an adjacent injector body 21. The injector body 21 has a reduced diameter region 55 (indicated generally) adjacent the nozzle body 13b, which is of substantially identical diameter to the second region 13b of the nozzle body 3. The compression sleeve 10 is arranged for engagement with the second region 13b of the nozzle body 13b and the region 55 of the injector body 21, and is located across the substantially flat interface 57 between the injector body 21 and the nozzle body 3. In this way, the compression sleeve 10 acts to maintain the injector body 21 and nozzle body 3 in a defined spatial relationship; i.e. the compression sleeve 10 restrains the components in an exact concentric relationship in which the longitudinal axes are in alignment. The use of the compression sleeve 10 of the invention in this manner can aid the assembly of a fuel injector and improve its performance.

In the embodiment shown in FIG. 6 it will be appreciated that the axial length L of the compression sleeve may be any desired length, provided that the length is suitable to adequately engage both components. It will be further appreciated that in such embodiments, the compression sleeve 10 may serve more than one function purpose, such as: (i) to reduce the hoop stress on one or both of the components (in this case the nozzle body 3 and the injector body 21); and (ii) to maintain the spatial relationship of the components; and (iii) to strength a joint or interface between two or more components, for example, to improve the seal between the components.

Although the injector body 21 shown in FIG. 6 has a region 55 of reduced diameter, it should be recognised that in related embodiments, the injector body 21 may have substantially the same diameter (as the region 55) along its entire length. In some cases, it may be desirable to modify the design of a known injector body 21 to provide a region 55 of substantially identical diameter to the nozzle body 3 against which it is to be located, in use.

The use of a compression sleeve 10 in this manner may greatly simplify the manufacturing and assembly process of fuel injector assemblies and internal combustion engines; as well as potentially increasing the lifespan of various assemblies of components and reducing maintenance issues (for example, by reducing fuel leaks).

An important element of the invention is that the addition of compressive pre-load onto suitable engine components results in higher pressure handling capabilities than would be achieved by just the addition of extra material. In this way, the maximum pressure handling capabilities of a fuel injection engine, its fuel injector assembly, or a component of the engine or the fuel injector assembly may be increased. Suitably, the pressure handling capability of a component is increased by at least 5%, for example, at least 10%, more suitably at least 20%, or even at least 50%. Accordingly, the pressure handling capability of a component, a fuel injector assembly and ultimately a fuel injection engine may be increased from e.g. 2500 bar, to 2750 bar, more suitably 3000 bar, still more suitably 3500 bar, or more.

Furthermore, by using a compression sleeve as described herein and, as a consequence, increasing the fuel pressure that can be used within an internal combustion engine, particularly a compression ignition (or diesel) internal combustion engine, engine efficiency and power may be improved and exhaust emissions may be reduced.

An extension of this concept is to use the compression sleeve as the locating feature, e.g. for the other injector components (as described). This may simplify manufacture, lead to improvements in concentricity between the components, and/or give improvements in interface seals.

Although in FIG. 1 a piezoelectric actuator is depicted, it should be appreciated that the fuel injector assembly embodiments may comprise any type of actuator, such as a solenoid actuator. The injectors may be of the deenergize-to-inject variety, in which a fuel injection event is triggered by the discharge of the actuator; or of the energize-to-inject type.

1. A fuel injector comprising an open-ended nozzle body, an injector body and a valve member engaged with a valve member guide in the nozzle body and a valve member guide in the injector body characterised in that the mating interface between the nozzle body and the injector body is substantially flat and in that a compression element is engaged with at least a part of each of the nozzle body and the injector body wherein the compression element applies a compressive stress to at least one of the nozzle body and the injector body.

2. A fuel injector as claimed in claim 1, wherein the nozzle body has a wall defining an internal chamber for high pressure fuel, the wall having an internal and an external surface, and wherein the compression element has an inner peripheral surface defining an aperture in which at least a portion of the nozzle body is received, in use, wherein the compression element is arranged for engagement as an interference fit with at least a portion of the external surface of the wall of the nozzle body, such that a radial compressive force is exerted on the wall of the nozzle body.

3. A fuel injector as claimed in claim 1 or claim 2, wherein the nozzle body is located axially adjacent the injector body, and wherein the compression element is arranged for engagement with at least a portion of the external surface of the injector body and at least a portion of the external surface of the nozzle body.

4. A fuel injector as claimed in claim 1, wherein the compression element is a sleeve.
